(19) United States
(12) Patent Application Publication
(10) Pub. No.: US 2017/0165963 A1
(43) Pub. Date: Jun. 15, 2017

(54) Printing Method for UV Inkjet Printer capable of Eliminating Printing Defects

(71) Applicant: GREAT COMPUTER CORPORATION, New Taipei City (TW)

(72) Inventors: Chen-Chien TSAI, New Taipei City (TW); Chia-Shou LAI, New Taipei City (TW); Chih-Hua YEN, New Taipei City (TW); Yu-Hung TANG, New Taipei City (TW)

(21) Appl. No.: 14/969,967

(22) Filed: Dec. 15, 2015

(51) Int. Cl. B41J 2/045

(52) U.S. Cl. CPC B41J 2/04536

(57) ABSTRACT

A printing method for UV inkjet printer capable of eliminating printing defects is provided, wherein each printing area of data to be printed is broken down into a plurality of printing data of printing passes; a first mask data is used for performing a first mask process to each leftward printing data of a spot color ink cartridge in the printing data of the printing passes; a second mask data is used for performing a second mask process to each rightward printing data of a spot color ink cartridge in the printing data of the printing passes; and the processed leftward and rightward printing data are printed by the spot color ink cartridge to form a special grain on a printed object surface, thereby visually eliminate the visible printing defects produced in the superimposition by the inkjet module.

### BACKGROUND OF THE INVENTION

Field of Invention

The present invention relates to a printing method for UV inkjet printer capable of eliminating printing defects and more particularly to a printing method that employs mask processes for printing data of a spot color ink cartridge in order to visually eliminate visible printing defects produced in the superimposition by the inkjet module.

Related Art

Due to the characteristics of UV ink of superimposition for superimposing thickness, it is therefore commonly applied in specialized 3D printing such as embossment and Braille. In order to enrich the color tones of a printed object, a UV inkjet printer performs multi-passes based on the image file size and resolution of a to-be-printed image when the UV inkjet printer employs a color separation software to separate the colors. The print head prints the data to be printed fractionally on the printed object repeatedly and superimposes color inks thereon, and thus a same inkjet location is accumulated with ink dots printed in each of the multi-passes in order to present a multilevel printing effect. Regarding the printing technique of multi-passes, please refer to the printing methods and devices provided in U.S. Pat. Nos. 5,469,198 and 5,923,349.

However, the print head nozzle can be easily blocked and damaged when the ink is used up or after the nozzle has been used for a long period of time. Therefore, after superimposition, banding (e.g. a fine line is produced on each row of a pattern) is formed on the pixel location of the printed object corresponding to the damaged nozzle; or the error produced by feed control of the inkjet module is enlarged on the same pixel location. As a result, abnormal bandings are printed and thus the print quality is affected tremendously and the cost and resources are wasted. Because the above mentioned printing defects produced during superimposition cannot be avoided in the printing technique of UV 3D and embossing (e.g. DCS) in the current market, there are still improvements to be made in the printing technique.

Therefore, methods for effectively improving the above mentioned printing defects produced during superimposition performed by UV inkjet printer in order to enhance the print quality of UV inkjet printer are eagerly sought after by technicians and users in the field.

### SUMMARY OF THE INVENTION

A primary objective of the present invention is to provide a printing method for UV inkjet printer capable of eliminating printing defects that employs mask processes for printing data of a spot color ink cartridge in printing data of printing passes in order to visually eliminate printing defects produced in the superimposition by the UV inkjet printer.

A secondary objective of the present invention is to provide a printing method for UV inkjet printer capable of eliminating printing defects that employs same or different mask processes for leftward and rightward printing data of a spot color ink cartridge in printing data of printing passes in order to produce special three-dimensional watermarking effect on superimposed locations and to enhance the print quality and special applications.

In order to achieved the above mentioned objectives, a printing method for UV inkjet printer capable of eliminating printing defects of the present invention provided comprises steps of: each printing area of data to be printed is broken down into a plurality of printing data of printing passes, the printing data of each of the printing passes comprise a plurality of pixel data; a first mask data is used for performing a first mask process to each leftward printing data of a spot color ink cartridge in the printing data of the passes to be printed; and a second mask data is used for proceeding a second mask process to each rightward printing data of a spot color ink cartridge in the printing data of the passes to be printed. Thereby, the leftward printing data and the rightward printing data that have been processed with the first mask process and the second mask process are printed by the spot color ink cartridge of an inkjet module until the data to be printed is all printed.

In practice, the first mask data is produced by randomly deleting the pixel data of the leftward printing data of the spot color ink cartridge.

In practice, the second mask data is produced by randomly deleting the pixel data of the rightward printing data of the spot color ink cartridge.

In practice, the first mask data is a preset graphic data for performing an intersection with the leftward printing data of the spot color ink cartridge.

In practice, the second mask data is a preset graphic data for performing an intersection with the rightward printing data of the spot color ink cartridge.

In practice, the first mask data and the second mask data are the same mask data or different mask data.

In practice, the spot color ink in the spot color ink cartridge is UV-curable transparent ink or UV-curable white ink.

The present invention will become more fully understood by reference to the following detailed description thereof when read in conjunction with the attached drawings.

### BRIEF DESCRIPTION OF THE DRAWINGS

FIG. 1 is a perspective view of a UV inkjet printer of the present invention.

FIG. 2 are printing steps of an embodiment of a printing method for UV inkjet printer capable of eliminating printing defects for the UV inkjet printer of the present invention.

FIG. 3A is a schematic view of a first mask data of the embodiment of printing steps in FIG. 2;

FIG. 3B is a schematic view of the leftward printing data to be printed processed with a first mask process of the embodiment in FIG. 3A;

FIG. 4A is a schematic view of a second mask data of the embodiment of printing steps in FIG. 3A;

FIG. 4B is a schematic view of the rightward printing data to be printed processed with a second mask process of the embodiment of printing steps in FIG. 3A; and

FIG. 5 is a schematic view of a printed graphic of the embodiment in FIG. 3A.

### DETAILED DESCRIPTION OF THE INVENTION

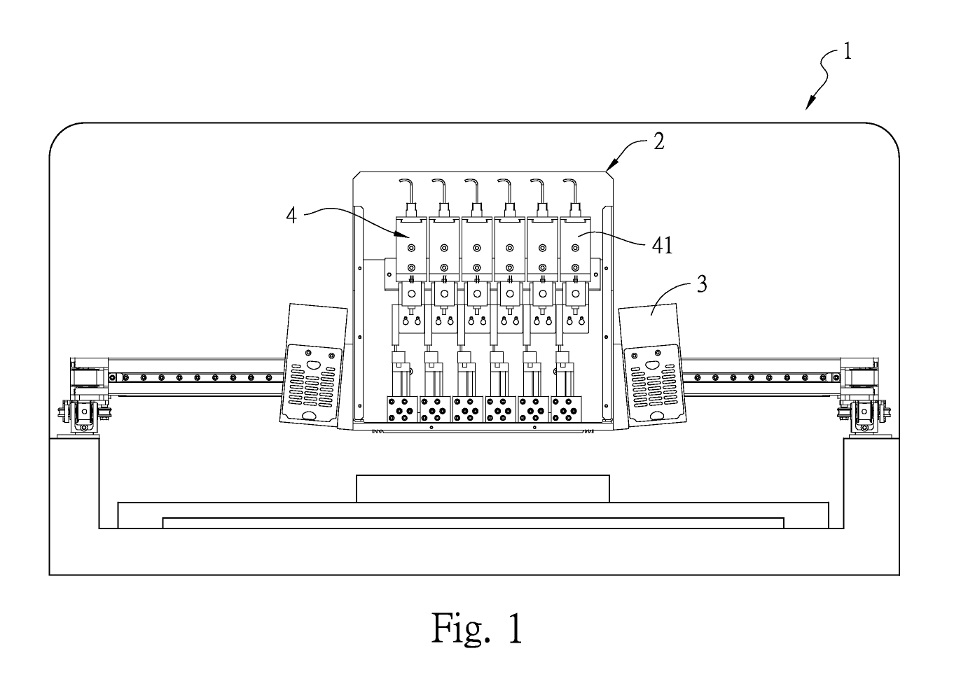

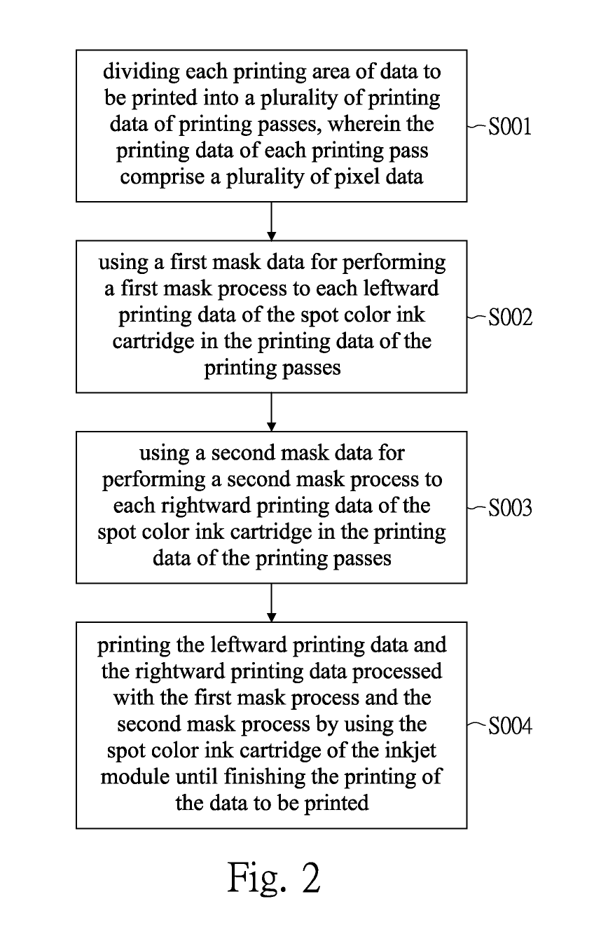

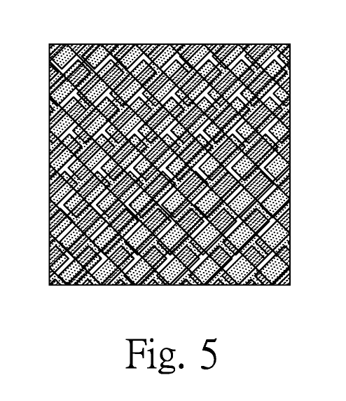

Please refer to FIGS. 1 to 5, which are one embodiment of a printing method for UV inkjet printer capable of eliminating printing defects of the present invention. The UV inkjet printer 1 comprises an inkjet module 2 and a UV projection device 3 disposed by left and right sides of the inkjet module 2. The inkjet module 2 moves left and right reciprocally along a slide rail above a printed object on a printing path in perpendicular to the printing path in order to perform printing tasks of graphical data to be printed. Furthermore, the inkjet module 2 comprises a plurality of color ink cartridges 4 and a spot color ink cartridge 41. The spot color ink cartridge 41 is filled with UV-curable transparent ink. After the ink is ejected by a nozzle of the inkjet module 2 onto the printed object, the ink is cured by the UV light produced by the UV projection device 3. The printing method for UV inkjet printer capable of eliminating printing defects comprises following steps of:

1. dividing each printing area of data to be printed into a plurality of printing data of printing passes, wherein the printing data of each printing pass comprise a plurality of pixel data;

2. using a first mask data for performing a first mask process to each leftward printing data of the spot color ink cartridge in the printing data of the printing passes;

3. using a second mask data for performing a second mask process to each rightward printing data of the spot color ink cartridge in the printing data of the printing passes; and

4. printing the leftward printing data and the rightward printing data processed with the first mask process and the second mask process by using the spot color ink cartridge of the inkjet module 2 until finishing the printing of the data to be printed.

The UV inkjet printer 1 employs a color separation software to separate the colors of an image to be printed, and divides each printing area of the data to be printed into the printing data of the printing passes based on the image file size and resolution of the image to be printed. The printing data of each of the printing passes comprise the pixel data. Thereby, the adjacent printing data are distributed in different printing passes and printed orderly. Four printing passes are used in the embodiment, and the printing data are printed in four separate times. The printing tasks moving from rightward to leftward performed by the inkjet module 2 are served as the first and the third printing passes; and the printing tasks moving from leftward to rightward performed by the inkjet module 2 are served as the second and the fourth printing passes.

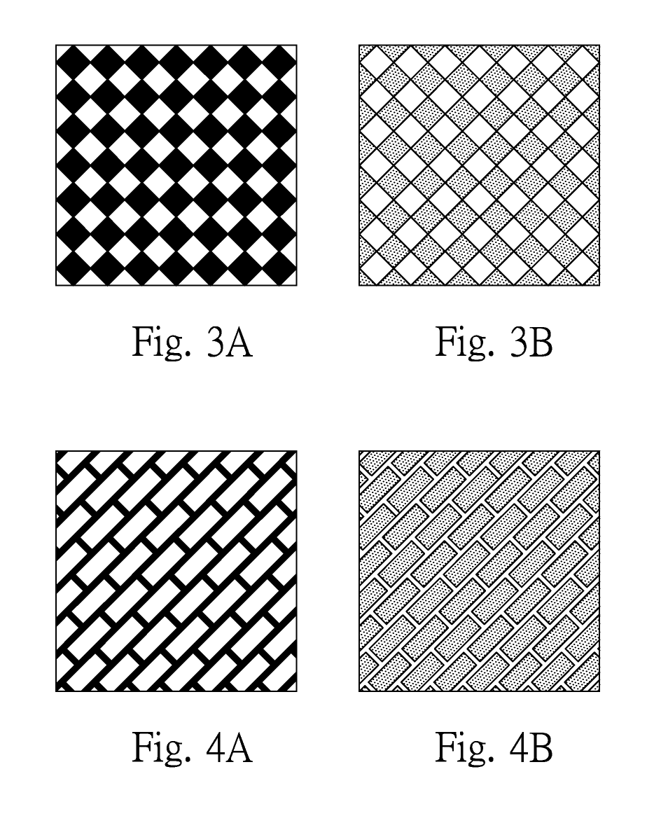

After the times of the printing passes are decided, the first mask data is used for performing the first mask process to the leftward printing data of the spot color ink cartridge 41 in the printing data of a first printing pass. The first mask data is a randomly produced graphic data with randomly blanked pixel data, and used for masking portions of the pixel data of the leftward printing data of the spot color ink cartridge 41 (as shown in FIG. 3A). When the first mask process is performed, the printing data of the first printing pass of the spot color ink cartridge 41 are performed an intersection with the first mask data. Thereby, when a color ink cartridge and the spot color ink cartridge perform the first printing pass, the spot color ink cartridge will not eject transparent ink on the pixel data locations corresponding to the mask. The print result is shown in FIG. 3B.

After the first printing pass is finished, the second mask data is used for performing the second mask process to the rightward printing data of the spot color ink cartridge 41 in the printing data of a second printing pass. The second mask data is a randomly produced with randomly blanked pixel data, and used for masking portions of the pixel data of the rightward printing data of the spot color ink cartridge 41 (as shown in FIG. 4A). When the second mask process is performed, the printing data of the second printing pass of the spot color ink cartridge 41 are performed an intersection with the second mask data. Thereby, when the color ink cartridge 4 and the spot color ink cartridge 41 perform the second printing pass, the spot color ink cartridge 41 will not eject transparent ink on the pixel data locations corresponding to the mask. The print result is shown in FIG. 4B. And so forth, it works the same for the ink ejection of the spot color ink cartridge 41 for the third and the fourth printing passes.

In this embodiment, the first mask data and the second mask data are different mask data. After all the printing areas of the data to be printed are printed as well as the first mask process and the second mask process are performed, a special grain is formed by the superimposed transparent ink on the printed object. The special grain disables viewers from visually seeing visible printing defects such as bandings produced in superimposition by the inkjet module. Thus, the visible printing defects are eliminated.

In other embodiments, the first mask data and the second mask data are the same mask data in order to produce special three-dimensional watermarking effect (such as fabric pattern or watermarking embossment) on superimposed locations on the printed object. Not only that the visible printing defects produced by the inkjet module are visually eliminated, the print quality of the printed object is also enhanced.

In other embodiments, the first mask data and the second mask data are a preset graphic data (such as a specific designed graphic defined by a user). The first mask data and the second mask data are the same mask data or different mask data for performing an intersection respectively with the leftward printing data and the rightward printing data of the spot color ink cartridge 41, and producing a special grain on the printed object and visually eliminating the visible printing defects produced by the inkjet module.

In other embodiments, the spot color ink filled in the spot color ink cartridge is UV-curable white ink or one of the four colors of CMYK (cyan, magenta, yellow, key) or other special color (such as fluorochrome or metallic color), depending on the spot color ink type specified by the color separation software.

A conclusion based on the content disclosed above, the printing method for UV inkjet printer capable of eliminating printing defects of the present invention can achieve the expected objectives. The printing method for UV inkjet printer is provided for visually eliminating the visible printing defects produced in the superimposition by the inkjet module and enhancing the applications of the UV inkjet printer and the print quality of the printed object.

Although the embodiments of the present invention have been described in detail, many modifications and variations may be made by those skilled in the art from the teachings disclosed hereinabove. Therefore, it should be understood that any modification and variation equivalent to the spirit of the present invention be regarded to fall into the scope defined by the appended claims.

1. A printing method for a UV inkjet printer capable of eliminating printing defects, the UV inkjet printer comprising an inkjet module and at least one UV projection device disposed by a side of the inkjet module, the inkjet module comprising a plurality of color ink cartridges and at least one spot color ink cartridge, the inkjet module performing a printing task of data to be printed by moving left and right reciprocally, the printing method comprising following steps of:
dividing each printing area of data to be printed into a plurality of printing data of printing passes, wherein the printing data of each printing pass comprise a plurality of pixel data for the plurality of color ink cartridges and the at least one spot color ink cartridge;
using a first mask data for performing a first mask process to each leftward printing data of the spot color ink cartridge in the printing data of the printing passes;
using a second mask data for performing a second mask process to each rightward printing data of the spot color ink cartridge in the printing data of the printing passes; and
printing the leftward printing data and the rightward printing data processed with the first mask process and the second mask process by using the spot color ink cartridge of the inkjet module until finishing the printing of the data to be printed.

2. The printing method according to claim 1, wherein the first mask data is a randomly produced graphic data for masking portions of the pixel data of the leftward printing data of the spot color ink cartridge.

3. The printing method according to claim 2, wherein the second mask data is a randomly produced graphic data for masking portions of the pixel data of the rightward printing data of the spot color ink cartridge.

4. The printing method according to claim 3, wherein the first mask data and the second mask data are the same mask data.

5. The printing method according to claim 3, wherein the first mask data and the second mask data are different mask data.

6. The printing method according to claim 1, wherein the second mask data is a randomly produced graphic data for masking portions of the pixel data of the rightward printing data of the spot color ink cartridge.

7. The printing method according to claim 1, wherein the first mask data is a preset graphic data for performing an intersection with the leftward printing data of the spot color ink cartridge.

8. The printing method according to claim 7, wherein the second mask data is a preset graphic data for performing an intersection with the rightward printing data of the spot color ink cartridge.

9. The printing method according to claim 8, wherein the first mask data and the second mask data are the same mask data.

10. The printing method according to claim 8, wherein the first mask data and the second mask data are different mask data.

11. The printing method according to claim 1, wherein the spot color ink in the spot color ink cartridge is UV-curable transparent ink.

12. The printing method according to claim 1, wherein the spot color ink in the spot color ink cartridge is UV-curable white ink.
